(19) United States
(12) Patent Application Publication
(10) Pub. No.: US 2026/0141249 A1
(43) Pub. Date: May 21, 2026

(54) METHOD FOR TRAINING CLASSIFICATION MODEL AND COMPUTING DEVICE FOR PERFORMING THE SAME

(71) Applicant: FOUNDATION OF SOONGSIL UNIVERSITY-INDUSTRY COOPERATION, Seoul (KR)

(72) Inventors: MINHAE KWON, Seoul (KR); MUGON JOE, Seoul (KR); MIRU KIM, Seoul (KR)

(21) Appl. No.: 19/048,192

(22) Filed: Feb. 7, 2025

(30) Foreign Application Priority Data
Nov. 15, 2024 (KR) 10-2024-0162776

(51) Int. Cl. G06N 3/09

(52) U.S. Cl. CPC G06N 3/09

(57) ABSTRACT

A method for training a classification model includes sequentially selecting a first data pair from a training dataset and stochastically selecting a second data pair from the training dataset, and inputting the first and second data pairs to a classification model to train the classification model, wherein each of the first and second data pairs includes data and a label corresponding to the data.

### CROSS REFERENCE TO RELATED APPLICATIONS AND CLAIM OF PRIORITY

This application claims the benefit under 35 USC § 119(a) of Korean Patent Application No. 10-2024-0162776, filed on Nov. 15, 2024 in the Korean Intellectual Property Office, the entire disclosure of which is incorporated herein by reference for all purposes.

### BACKGROUND

### 1. Field

The following description relates to a technology for training a classification model.

### 2. Description of Related Art

Typically an artificial intelligence model is trained based on data collected in advance and then the trained artificial intelligence model is distributed and utilized for data generated in real time. However, data imbalance (namely, class imbalance) may frequently occur when data with a specific label is excessively more or less than data with another label in a pre-training phase of artificial intelligence. Such a data imbalance issue may cause an artificial intelligence model to be skewed toward majority labels, and thus the prediction performance of the model for a minority class may be significantly reduced.

In addition, the artificial intelligence model is optimized to the distribution of data used in the pre-training phase, and thus when the artificial intelligence model is distributed and utilized, a change in data distribution occurring in real time may cause degradation of the performance of the artificial intelligence model. In particular, when the label distribution of training data is different from the label distribution of data collected in real time, there is a risk that the prediction performance of the artificial intelligence is rapidly degraded. FIG. 1 shows class imbalance in a pre-training phase and a state in which the label distribution changes over time in an adaptation phase.

Accordingly, it is required to address an class imbalance issue in the pre-training phase and prevent the degradation in the prediction performance of the artificial intelligence model even in an environment in which the label distribution changes.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a method for training a classification model so that a class imbalance issue is addressed in a pre-training phase and the prediction performance of an artificial intelligence model is not degraded even in an environment in which the label distribution changes, and a computing device for performing the same.

In one general aspect, there is provided a method for training a classification model performed by a computing device including one or more processors and a memory storing one or more programs executed by the one or more processors, the method including: sequentially selecting a first data pair from a training dataset and stochastically selecting a second data pair from the training dataset; and inputting the first and second data pairs to a classification model to train the classification model, wherein each of the first and second data pairs includes data and a label corresponding to the data.

In the selecting of the second data pair, data corresponding to a minority label may be allowed to be selected at a higher probability than data corresponding to a majority label in the training dataset.

In the training of the classification model, the classification model may be trained by a first cross entropy loss function and a first contrastive loss function. The first cross entropy loss function may include: a (1-1)-th cross entropy loss function for minimizing a difference between a class predicted by the classification model for first data between the first data pair and a label of the first data between the first data pair; and a (1-2)-th cross-entropy loss function for minimizing a difference between a class predicted by the classification model for second data between the second data pair and a label of the second data between the second data pair. The first contrast loss function may be a loss function for causing same labels to be closer and different labels to be further apart in latent vectors output from one or more hidden layers of the classification model.

The method may further include selecting, as a boundary sample, a piece of data that is a latent vector output from the hidden layer of the classification model and positioned at a boundary of the label.

The selecting as the boundary sample may include: calculating a Mahalanobis distance between a distribution of the labels and the latent vector output from the hidden layer of the classification model; and selecting, as the boundary sample of the corresponding label, the latent vector with the Mahalanobis distance no smaller than a preset threshold value.

The method may further include: setting an anchor sample for each of the labels based on the Mahalanobis distance; and performing additional training on the classification model based on the boundary sample and the anchor sample for each of the labels.

In the setting of the anchor sample, a latent vector with a minimum Mahalanobis distance may be set as the anchor sample for each of the labels.

The performing of the additional training may include performing the additional training using a second contrastive loss function that causes a distance between the anchor sample and the boundary sample in each of labels to be closer.

The method may further include determining whether to perform adaptation on the trained classification model based on data collected in real time.

The determining of whether to perform the adaptation may include: calculating a similarity between an output of the classification model for current time data and an output of the classification model for previous time data; and determining not to perform the adaptation when the calculated similarity is not smaller than a preset similarity threshold value.

The determining of whether to perform the adaptation may include: calculating an entropy value of the classification model for a dataset collected in real time; and determining not to perform the adaptation when the calculated entropy value of the classification model is smaller than a first preset entropy threshold value.

The method may further include: generating a pseudo label for each piece of data input to the classification model when the adaptation is determined to be performed; and performing the adaptation on the trained classification model based on pieces of data for which the pseudo label have been generated.

The generating of the pseudo label may include: calculating an entropy value of the classification model for each piece of data input to the classification model; and setting a predicted value of the classification model as a pseudo label for the corresponding data when the calculated entropy value of the classification model is smaller than a second preset entropy threshold value.

In the generating of the pseudo label, a pseudo label may be generated based on a latent vector that is an output from the hidden layer of the classification model for the corresponding data when the calculated entropy value of the classification model is not smaller than the second preset entropy threshold value.

The generating of the pseudo label may include: calculating Mahalanobis distances between a distribution of the labels and the latent vector for the corresponding data; and generating the pseudo label for the corresponding data based on the calculated Mahalanobis distances.

The generating of the pseudo label may include: calculating a difference between a minimum Mahalanobis distance and a next minimum Mahalanobis distance; and setting a label with a smallest Mahalanobis distance as the pseudo label for the corresponding data when the calculated difference is not smaller than a preset threshold value.

In the generating of the pseudo label, the pseudo label may not be generated for the corresponding data when the calculated difference is smaller than the preset threshold value.

In another general aspect, there is provided a computing device including: one or more processors; a memory; and one or more programs, wherein the one or more programs are stored in the memory and executed by the one or more processors, and include an instruction for sequentially selecting a first data pair from a training dataset and stochastically selecting a second data pair from the training dataset, and an instruction for inputting the first and second data pairs to a classification model to train the classification model, wherein each of the first and second data pairs includes data and a label corresponding to the data.

In still another general aspect, there is provided a computer program stored in a non-transitory computer readable storage medium and including one or more instructions, wherein, when executed by a computing device including one or more processors, the instructions cause the computing device to perform: sequentially selecting a first data pair from a training dataset and stochastically selecting a second data pair from the training dataset; and inputting the first and second data pairs to a classification model to train the classification model, wherein each of the first and second data pairs includes data and a label corresponding to the data.

Other features and aspects will be apparent from the following detailed description, the drawings, and the claims.

### BRIEF DESCRIPTION OF THE DRAWINGS

FIG. 1 shows a class imbalance issue in a pre-training phase and a state in which the label distribution changes over time in an adaptation phase.

FIG. 2 shows the configuration of a device for training a classification model according to an embodiment of the present disclosure.

FIG. 3 is a block diagram showing the configuration of a pre-training module according to an embodiment of the present disclosure.

FIG. 4 shows an anchor sample and a boundary sample of each label in a latent representation space according to an embodiment of the present disclosure.

FIG. 5 is a block diagram showing the configuration of an adaptation module according to an embodiment of the present disclosure.

FIG. 6 shows a device for training a classification model according to another embodiment of the present disclosure.

FIG. 7 is a flowchart illustrating a method for training a classification model according to an embodiment of the present disclosure.

FIG. 8 is a flowchart illustrating a method for training a classification model according to another embodiment of the present disclosure.

FIG. 9 is a block diagram illustrating and describing a computing environment including a computing device suitable for use in illustrative embodiments.

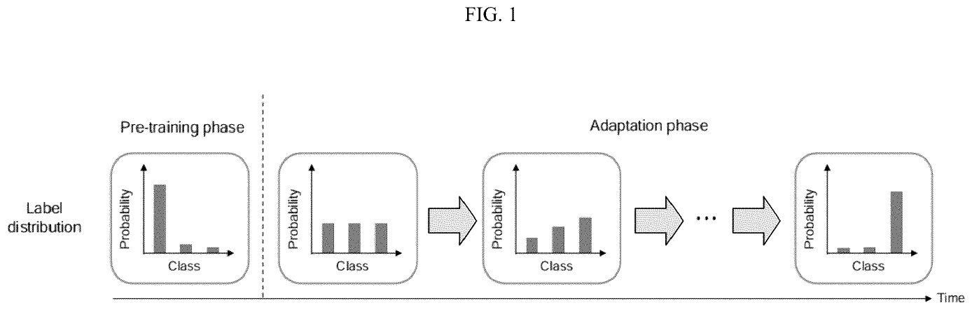

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made based on the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

FIG. 2 shows the configuration of a device for training a classification model according to an embodiment of the present disclosure.

Referring to FIG. 2, the device for training a classification model may include a pre-training module 102 and an adaptation module 104. In an embodiment, the classification model may be an artificial intelligence model for performing network intrusion type classification, network traffic classification, facility fault cause classification, object classification, image classification, weather type classification, medical diagnosis classification, or the like, but the task performed by the classification model is not limited thereto. A training phase of the classification model may include pre-training and adaptation.

The pre-training module 102 may perform the pre-training on the classification model. The pre-training module 102 may train the classification module using a training dataset collected in advance without an online change in the label distribution.

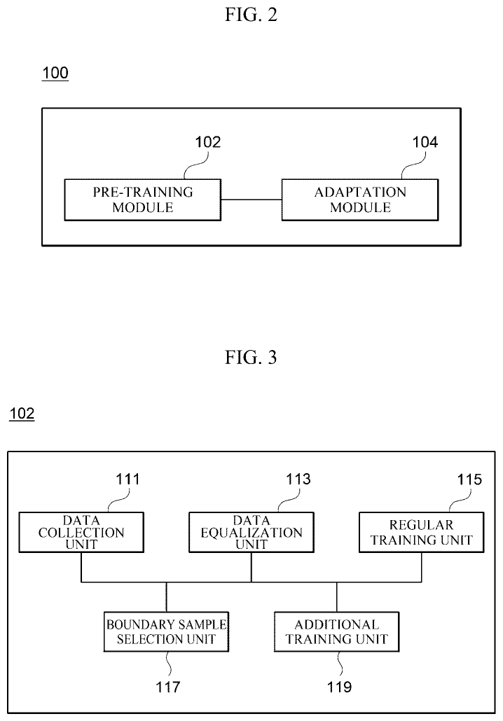

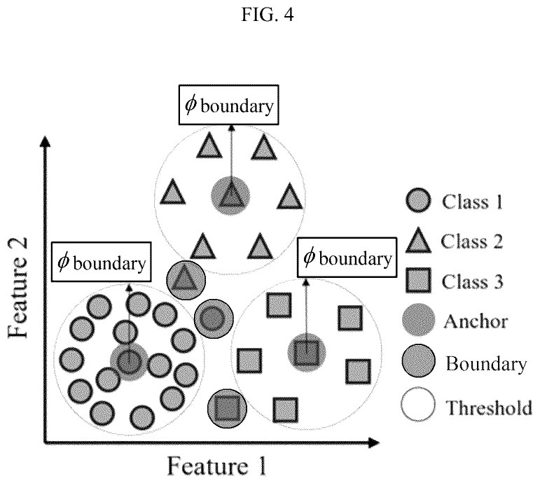

FIG. 3 is a block diagram showing the configuration of the pre-training module 102 according to an embodiment of the present disclosure. Referring to FIG. 3, the pre-training module 102 may include a data collection unit 111, a data equalization unit 113, a regular training unit 115, a boundary sample selection unit 117, and an additional training unit 119.

The data collection unit 111 may collect a training dataset for training the classification model. The data collection unit 111 may perform matching each piece of training data in the training dataset with a label corresponding to the training data, and store the matching result. In this case, the training dataset may be denoted as

$${X}^{0} = {⌊ {x}_{i}^{0} ⌋}_{i = 1}^{{N}^{0}} ,$$

and a label dataset corresponding thereto may be denoted as

$${Y}^{0} = {⌊ {y}_{i}^{0} ⌋}_{i = 1}^{{N}^{0}} .$$

N⁰ denotes the total number of the pieces of training data. yᵢ⁰ denotes a label for a data sample xᵢ⁰. The pre-training of the classification model may be defined at time t=0. Namely, the superscript 0 in xᵢ⁰ and yᵢ⁰ indicates the pre-training phase.

The data equalization unit 113 may equally sample the pieces of training data having label imbalance. Specifically, the data equalization unit 113 may select a data pair (namely, training data and a label corresponding thereto) to be input to the classification model in order to pre-train the classification model. Here, the data equalization unit 113 may sequentially select a first data pair (xᵢ⁰, yᵢ⁰) from the training dataset and stochastically randomly select a second data pair (xⱼ⁰, yⱼ⁰) from the training dataset. All the first data pair (xᵢ⁰, yᵢ⁰) and second data pair (xⱼ⁰, yⱼ⁰) may be input to the classification model.

Here, the data equalization unit 113 may select the second data pair (xⱼ⁰, yⱼ⁰) by giving the priority to training data corresponding to a minority label in the training dataset. In other words, the data equalization unit 113 may select the second data pair (xⱼ⁰, yⱼ⁰) so that the training data corresponding to the minority label in the training dataset is selected at a higher probability than that corresponding to a majority label. Namely, when the label distribution of the training data is denoted as Ω⁰(c), the second data pair (xⱼ⁰, yⱼ⁰) may be selected using 1−Ω⁰(c). In this case, a label with low distribution may be selected at a higher probability than a label with high distribution. In this way, the label imbalance in the training data to be input to the classification model may be prevented.

The regular training unit 115 may input the first data pair (xᵢ⁰, yᵢ⁰) and the second data pair (xⱼ⁰, yⱼ⁰) to the classification model to train the classification model. Here, the classification model is a neural network including L hidden layers. The classification model may receive first data xᵢ⁰ and second data xⱼ⁰ and be trained to classify the classes of the first data xᵢ⁰ and the second data xⱼ⁰.

The regular training unit 115 may train the classification model using a first cross-entropy loss function and a first contrastive loss function.

Here, the first cross-entropy loss function may include a (1-1)-th cross entropy loss function for minimizing the difference between the class predicted by the classification model for the first data xᵢ⁰ and a correct answer value, namely, label yᵢ⁰ of the first data, and a (1-2)-th cross entropy loss function for minimizing the difference between the class predicted by the classification model for the second data xⱼ⁰ and a correct answer value, namely, label yⱼ⁰ of the second data. In addition, the first contrastive loss function may be a loss function for causing the distance between the same labels to be closer and the distance between different labels further apart in latent vectors output from one or more hidden layers of the classification model.

The regular training unit 115 may train the classification model based on a regular training loss function formed by the sum of the first cross entropy loss function and the first contrastive loss function. Here, the regular training loss function

$${ℒ}_{pre} ( {x}_{i}^{0} , {x}_{j}^{0} , {y}_{i}^{0} , {y}_{j}^{0} ; {θ}^{0} )$$

may be expressed as the following Equation 1.

$${ℒ}_{pre} ( {x}_{i}^{0} , {x}_{j}^{0} , {y}_{i}^{0} , {y}_{j}^{0} ; {θ}^{0} ) = λ ( {ℒ}_{cross} ( {x}_{i}^{0} , {y}_{i}^{0} ; {θ}^{0} ) + {ℒ}_{cross} ( {x}_{j}^{0} , {y}_{j}^{0} ; {θ}^{0} ) ) + ( 1 - λ ) {ℒ}_{cont} ( {x}_{i}^{0} , {x}_{j}^{0} , {y}_{i}^{0} , {y}_{j}^{0} ; {θ}^{0} \text{?} ) \qquad ( 1 )$$

$$\text{?} \text{indicates text missing or illegible when filed}$$

where θ⁰ denotes the classification model in the pre-training (t=0),

$${ℒ}_{cross} ( {x}_{i}^{0} , {y}_{i}^{0} ; {θ}^{0} )$$

denotes the (1-1)-th cross entropy loss function,

$${ℒ}_{cross} ( {x}_{j}^{0} , {y}_{j}^{0} ; {θ}^{0} )$$

denotes the (1-2)-th cross entropy loss function,

$${ℒ}_{cont} ( {x}_{i}^{0} , {x}_{j}^{0} , {y}_{i}^{0} , {y}_{j}^{0} ; {θ}^{0} \text{?} )$$

$$\text{?} \text{indicates text missing or illegible when filed}$$

denotes the first contrastive loss function,

$${θ}_{L}^{0} \text{?}$$

$$\text{?} \text{indicates text missing or illegible when filed}$$

denotes an output of an L̅-th hidden layer of the classification model, and λ denotes a preset hyper parameter.

In an embodiment, the (1-1)-th cross entropy loss function may be expressed as the following Equation 2. In addition, the (1-2)-th cross entropy loss function may also be expressed in the same manner.

$${ℒ}_{cross} ( {x}_{i}^{0} , {y}_{i}^{0} ; {θ}^{0} ) = − {\sum }_{c ∈ C} {p}_{{x}_{i}^{0}} ( c ) log {q}_{{x}_{i}^{0}} ( c ; {θ}^{0} ) \qquad ( 2 )$$

where c denotes a class (label), C denotes the total number of classes,

$${p}_{{x}_{i}^{0}} ( c )$$

denotes a probability (correct answer value) for class c of the first data, and

$${q}_{{x}_{i}^{0}} ( c ; {θ}^{0} )$$

denotes a probability of class c predicted for the first data by the classification model.

In addition, the first contrastive loss function may be expressed as the following Equation 3.

$${ℒ}_{cont} ( {x}_{i}^{0} , {y}_{i}^{0} , {μ}_{c} , {Σ}_{c} ; {θ}_{\text{?} \overline{L}}^{0} ) = [ {𝕀}_{\{ {y}_{i}^{0} = {y}_{j}^{0} \}} ( {‖ {θ}_{\text{?} \overline{L}}^{0} ( {x}_{i}^{0} ) - {θ}_{\text{?} \overline{L}}^{0} ( {x}_{j}^{0} ) ‖}_{2} ) + {𝕀}_{\{ {y}_{i}^{0} \neq {y}_{j}^{0} \}} ( max ( 0 , ϵ - {‖ {θ}_{\text{?} \overline{L}}^{0} ( {x}_{i}^{0} ) - {θ}_{\text{?} \overline{L}}^{0} ( {x}_{j}^{0} ) ‖}_{2} ) ) ] \qquad ( 3 )$$

$$\text{?} \text{indicates text missing or illegible when filed}$$

where ∥⋅∥₂ denotes a Euclidean distance, [symbol] denotes an indicator function, and ε denotes a preset margin.

Here, [symbol] is the indicator function and may be defined as the following Equation 4.

$${𝕀}_{\{ condition \}} = \{ \begin{matrix}1 , & if the condition is true \\ 0 , & otherwise\end{matrix} \qquad ( 4 )$$

Namely, the indicator function is 1 if the condition in parentheses is satisfied and 0 otherwise. Thus,

$${𝕀}_{\{ {y}_{i}^{0} = {y}_{j}^{0} \}}$$

in Equation 3 is 1 if labels yᵢ⁰ and yⱼ⁰ are the same and 0 otherwise. In addition,

$${𝕀}_{\{ {y}_{i}^{0} \neq {y}_{j}^{0} \}}$$

is 1 if labels yᵢ⁰ and yⱼ⁰ are not the same and 0 otherwise.

According to Equation 3, the classification model is trained so that if labels of the outputs (namely, the latent vectors) of the L̅-th hidden layer of the classification model are the same, the distance is closer, and if the labels of the outputs (namely, the latent vectors) of the L̅-th hidden layer of the classification model are not the same, the distance is further apart by the set margin ε.

In an embodiment, the L̅-th hidden layer of the classification model may be an intermediate layer in the classification model, but the embodiment is not limited thereto. Here, it is described that the training according to the first contrastive loss function is performed based on the output of the L̅-th hidden layer of the classification model, but the embodiment is not limited thereto. The training may be performed based on outputs of a plurality of hidden layers in the classification model. In addition, if necessary, different weights may be given to the plurality of hidden layers.

The boundary sample selection unit 117 may select data for additionally training the classification model that has been trained by the regular training unit 115. The boundary sample selection unit 117 may select, as a boundary sample for additional training, data that is the latent vector output from the hidden layer of the classification model and positioned at the boundary of a label in the latent representation space.

Specifically, according to how far the data is from the center of the label to which the data belongs in the latent representation space, the boundary sample selection unit 117 may determine whether the data is at the boundary of the label. In an embodiment, the boundary sample selection unit 117 may use the Mahalanobis distance in order to select the data positioned at the boundary of the label in the latent representation space.

The boundary sample selection unit 117 may calculate an average vector and a covariance matrix of pieces of data belonging to each label (namely, each class) in the latent representation space. Data in the latent representation space may mean a latent vector. Accordingly, the average vector of the pieces of data belonging to a prescribed label in the latent representation space may mean the average of the latent vectors belonging to the corresponding label. The boundary sample selection unit 117 may calculate the average vector of the pieces of data belonging to each of the labels using Equation 5.

$${μ}_{c} = E [ {θ}_{\text{?} \overline{L}}^{0} ( {x}_{i}^{0} ) \vert c = {y}_{i}^{0} ] \qquad ( 5 )$$

$$\text{?} \text{indicates text missing or illegible when filed}$$

where μ_{c} denotes the average vector of pieces of data belonging to label c. In addition, the boundary sample selection unit 117 may calculate a covariance matrix of pieces of data belonging to each of the labels using Equation 6.

$${\sum }_{c} = E [ ( {θ}_{\text{?} \overline{L}}^{0} ( {x}_{i}^{0} ) - {μ}_{c} ) {( {θ}_{\text{?} \overline{L}}^{0} ( {x}_{i}^{0} ) - {μ}_{c} )}^{T} \vert c = {y}_{i}^{0} ] \qquad ( 6 )$$

$$\text{?} \text{indicates text missing or illegible when filed}$$

where Σ_{c} denotes the covariance matrix of the pieces of data belonging to label c

The boundary sample selection unit 117 may calculate the Mahalanobis distance indicating how far each piece of data (namely, each latent vector) is from the distribution of the labels in the latent representation space based on the average vector and covariance matrix of the pieces of data belonging to each of the labels. The boundary sample selection unit 117 may calculate the Mahalanobis distance (D_{MD}) using Equation 7.

$${D}_{MD} ( {x}_{i}^{0} , {y}_{i}^{0} , {μ}_{c} , {Σ}_{c} ; {θ}_{\text{?} \overline{L}}^{0} ) = \sqrt{{( {θ}_{\text{?} \overline{L}}^{0} ( {x}_{i}^{0} ) - {μ}_{c} )}^{T} {\sum }_{c}^{- 1} ( {θ}_{\text{?} \overline{L}}^{0} ( {x}_{i}^{0} ) - {μ}_{c} )} \qquad ( 7 )$$

$$\text{?} \text{indicates text missing or illegible when filed}$$

Here, it may be understood that as greater the Mahalanobis distance (D_{MD}), the closer the latent vector (data) to the boundary of the label. The boundary sample selection unit 117 may select, as a boundary sample, a piece of data corresponding to a latent vector with the Mahalanobis distance (D_{MD}) no smaller than a preset threshold value.

The additional training unit 119 may additionally train the classification model that has been regularly trained. The additional training unit 119 may additionally train the classification model using a second contrastive loss function based on the boundary sample selected by the boundary sample selection unit 117. In order to perform the additional training using the second contrastive loss function, the additional training unit 119 may set an anchor sample for forming a contrastive pair with the boundary sample for each of the labels based on the Mahalanobis distance (D_{MD}).

The additional training unit 119 may set, as the anchor sample, a latent vector with the smallest Mahalanobis distance (D_{MD}) in each of the labels. Here, the latent vector with the smallest Mahalanobis distance (D_{MD}) corresponds to a latent vector closest to the center of the corresponding label. The additional training unit 119 may set the anchor sample in each of the labels using the following Equation 8.

$${x}_{a , c}^{0} = arg {min}_{{x}_{i}^{0} ∈ {X}^{0}} {D}_{MD} ( {x}_{i}^{0} , {y}_{i}^{0} , {μ}_{c} , {Σ}_{c} ; {θ}_{\text{?} \overline{L}}^{0} ) \qquad ( 8 )$$

$$\text{?} \text{indicates text missing or illegible when filed}$$

where

$${x}_{a , c}^{0}$$

denotes an anchor sample for label c.

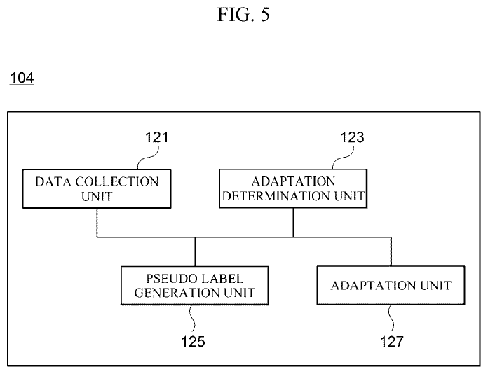

FIG. 4 shows an anchor sample and a boundary sample of each label in the latent representation space according to an embodiment of the present disclosure. Referring to FIG. 4, a sample closest to the center of each of the labels is set as the anchor sample, and a sample with the Mahalanobis distance (D_{MD}) no smaller than the preset threshold value (φ_{border}) is selected as the boundary sample.

The additional training unit 119 may perform the additional training using the second contrastive loss function based on the boundary sample and the anchor sample for each of the labels. The second contrastive loss function may be a loss function for causing the distance between the anchor sample and the boundary sample to be closer in each of the labels. Here, the second contrastive loss function may be expressed as Equation 9.

$${L}_{cont} ( {x}_{a , c}^{0} , {x}_{b , c}^{0} , {y}_{a , c}^{0} , {y}_{b , c}^{0} ; {θ}_{\text{?} \overline{L}}^{0} ) = [ {I}_{( {y}_{b , c}^{0} = {y}_{a , c}^{0} )} {‖ {θ}_{\text{?} \overline{L}}^{0} ( {x}_{b , c}^{0} ) - {θ}_{\text{?} \overline{L}}^{0} ( {x}_{a , c}^{0} ) ‖}_{2} \qquad ( 9 )$$

$$\text{?} \text{indicates text missing or illegible when filed}$$

where

$${L}_{cont} ( {x}_{a , c}^{0} , {x}_{b , c}^{0} , {y}_{a , c}^{0} , {y}_{b , c}^{0} ; {θ}_{\text{?} \overline{L}}^{0} )$$

$$\text{?} \text{indicates text missing or illegible when filed}$$

denotes the second contrastive loss function, x_{a,c}^{o} denotes the anchor sample for label c, x_{b,c}^{o} denotes the boundary sample for label c, y_{a,c}^{o} denotes the label corresponding to x_{a,c}^{o}, and y_{b,c}^{o} denotes the label corresponding to x_{b,c}^{o}.

According to Equation 9, when the label of the anchor sample and the label of the boundary sample are the same, the training may be performed so that the distance between the anchor sample and the boundary sample is minimized. In this case, the samples with the same label may gather together to improve the classification performance of the classification model.

Meanwhile, the additional training unit 119 may additionally train the classification model using a second cross entropy loss function other than the second contrastive loss function. Here, the second cross-entropy loss function may include a (2-1)-th cross entropy loss function for minimizing the difference between a class predicted by the classification model for the anchor sample x_{a,c}^{o} and a correct answer value (namely, y_{a,c}^{o}), and a (2-2)-th cross entropy loss function for minimizing the difference between a class predicted by the classification model for the boundary sample x_{b,c}^{o} and a correct answer value (namely, y_{b,c}^{o}).

In this way, the classification performance of the classification model may be improved even for data at the boundary of the label while addressing the label imbalance in the training dataset in the pre-training phase.

The adaptation module 104 may perform adaptation on the pre-trained classification model. The adaptation module 104 may perform the adaptation on the classification model in the environment in which the label distribution of the training dataset changes (e.g., the environment in which data is collected in real time). That is, the adaptation module 104 may perform the adaptation based on the data collected in real time and of which the label distribution changes.

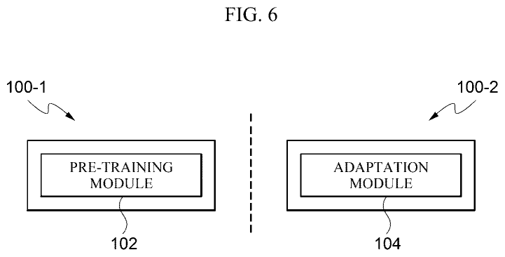

FIG. 5 is a block diagram showing the configuration of the adaptation module 104 according to an embodiment of the present disclosure. Referring to FIG. 5, the adaptation module 104 may include a data collection unit 121, an adaptation determination unit 123, a pseudo label generation unit 125, and an adaptation unit 127.

The data collection unit 121 may collect the real-time data. The data collection unit 121 may store the collected data. Here, the data collected in real time may not include label information. Typically, the amount of the data used in the adaptation is smaller than that of data used in the pre-training.

The adaptation determination unit 123 may determine whether to perform adaptation on the pre-trained classification model. The adaptation determination unit 123 may determine whether to perform the adaptation at each time (each time step). In an embodiment, the adaptation determination unit 123 may determine whether to perform the adaptation based on N^{t} datasets

$${X}^{t} = {[ {x}_{i}^{t} ]}_{i = 1}^{{N}^{t}}$$

collected at time t.

The adaptation determination unit 123 may determine whether to perform the adaptation based on the similarity between the current time data X^{t} and previous time data X^{t-1}. The similarity between the current time data X^{t} and the previous time data X^{t-1} may be calculated using the cosine similarity between an output q_{X}_{^{t}}(c;θ^{t}) of the classification model for the current time data X^{t} and an output q_{X}_{^{t-1}}(c;θ^{t}) of the classification model for the previous time data X^{t-1}. Here, the similarity may be calculated using the following Equation 10.

$$s ( {X}^{t} , {X}^{t - 1} ; {θ}^{t} ) = \frac{{\sum }_{c ∈ C} ( {q}_{{X}^{t}} ( c ; {θ}^{t} ) \cdot {q}_{{X}^{t - 1}} ( c ; {θ}^{t} ) )}{\sqrt{{\sum }_{c ∈ C} {( {q}_{{X}^{t}} ( c ; {θ}^{t} ) )}^{2}} \sqrt{{\sum }_{c ∈ C} {( {q}_{{X}^{t - 1}} ( c ; {θ}^{t} ) )}^{2}}} \qquad ( 10 )$$

where θ^{t} denotes the classification model, and C denotes the total number of classes.

The adaptation determination unit 123 may not determine to perform the adaptation if the similarity between the outputs of the classification model for the current time data X^{t} and the previous time data X^{t-1} is not smaller than a preset similarity threshold value.

In addition, the adaptation determination unit 123 may determine, based on an entropy value of the classification model, whether to perform the adaptation. Here, the entropy value

$$h ( {x}_{i}^{t} ; {θ}^{t} )$$

of the classification model indicates the prediction uncertainty of the classification model, and may be calculated using the following Equation 11. The entropy value of the classification model for determining whether to perform the adaptation may be calculated based on the output of the classification model for the entire dataset.

$$h ( {x}_{i}^{t} ; {θ}^{t} ) = - {\sum }_{c ∈ C} {q}_{{x}_{i}^{t}} ( c ; {θ}^{t} ) log {q}_{{x}_{i}^{t}} ( c ; {θ}^{t} ) \qquad ( 11 )$$

wherein

$${q}_{{x}_{i}^{t}} ( c ; {θ}^{t} )$$

denotes an output of the classification model θ^{t} for label c according to an input of data

$${x}_{i}^{t} .$$

Here, the adaptation determination unit 123 may not determine to perform the adaptation if the entropy value of the classification model is smaller than a first preset entropy threshold value.

The adaptation determination unit 123 may determine to perform the adaptation if the similarity between the outputs of the classification model for the current time data Xt and the previous time data Xt−1 is smaller than the similarity threshold value and the entropy value of the classification model is not smaller than the first preset entropy threshold value.

The pseudo label generation unit 125 may generate a pseudo label for each piece of data input to the classification model when the adaptation is determined to be performed. In other words, the data collected by the data collection unit 121 does not include label information, and thus a pseudo label for the data may be generated during the adaptation. The pseudo label may be generated for each piece of data in the dataset Xt at every time t.

The pseudo label generation unit 125 may select reliable data from the dataset to generate the pseudo label for the reliable data. Here, whether the data is reliable may be determined based on the reliability of the classification model.

Specifically, the pseudo label generation unit 125 may calculate the entropy value of the classification model for each piece of data input to the classification model, determine that a predicted result of the classification model for the corresponding data is reliable when the calculated entropy value of the classification model is smaller than a second preset entropy threshold value, and set the predicted value of the classification model as the pseudo label for the corresponding data.

Here, the second entropy threshold value may be set separately from the first entropy threshold value. The first entropy threshold value is set for the entropy value of the classification model for the entire dataset, and the second entropy threshold value is set for the entropy value of the classification model for individual data.

Meanwhile, when the entropy value of the classification model for the input data is not smaller than the second preset entropy threshold value, the pseudo label generation unit 125 may generate the pseudo label based on an output (namely, a latent vector) from the hidden layer of the classification model for the corresponding data. Specifically, the pseudo label generation unit 125 may calculate the Mahalanobis distance between the latent vector, which is the output from the hidden layer of the classification model for the corresponding data, and the distribution of the labels in the latent representation space.

The pseudo label generation unit 125 may calculate the Mahalanobis distance between the latent vector of the corresponding data and the distribution of the labels based on the average vector and covariance matrix of the pieces of data belonging to each of the labels in the latent representation space (refer to Equation 7). The pseudo label generation unit 125 may generate the pseudo label for the corresponding data based on the Mahalanobis distance between the latent vector of the corresponding data and the distribution of the labels.

The pseudo label generation unit 125 may select a label with the smallest Mahalanobis distance from among the labels to set as the pseudo label for the corresponding data. Here, the pseudo label generation unit 125 may set the label with the smallest Mahalanobis distance as the pseudo label for the corresponding data only when the difference between the smallest value (namely, the minimum distance) of the Mahalanobis distance and the next minimum Mahalanobis distance is not smaller than a preset threshold value.

The next minimum Mahalanobis distance means the smallest Mahalanobis distance except the minimum Mahalanobis distance among the Mahalanobis distances to the labels, namely, the second smallest Mahalanobis distance. The pseudo label generation unit 125 may set the label with the smallest Mahalanobis distance as the pseudo label for the corresponding data only when the difference between the minimum Mahalanobis distance and the next minimum Mahalanobis distance is not smaller than the preset threshold value.

If the difference between the minimum Mahalanobis distance and the next minimum Mahalanobis distance is smaller than the preset threshold value, the pseudo label generation unit 125 may determine that the pseudo label for the corresponding data is not reliable, and not generate the pseudo label for the corresponding data and not use for the adaptation. The generation of the pseudo label for the data to be input to the classification model may be expressed as the following Equation 12.

$${\tilde{y}}_{i}^{t} = \{ \begin{matrix}{\hat{y}}_{i}^{t} , & if h ( {x}_{i}^{t} ; {θ}^{t} ) < {ϕ}_{pred} \\ arg {min}_{c ∈ C} {D}_{MD} ( {x}_{i}^{t} , {y}_{i}^{t} , {μ}_{c} , {\sum }_{c} ; {θ}^{t} ) , & \begin{matrix}if h ( {x}_{i}^{t} ; {θ}^{t} ) \geq {ϕ}_{pred} \\ and {Δ}_{MD} \geq {ϕ}_{MD}\end{matrix} \\ No pseudo - labeling , & otherwise\end{matrix} \qquad ( 12 )$$

where

$${\tilde{y}}_{i}^{t}$$

denotes the pseudo label for

$${x}_{i}^{t} , {\hat{y}}_{i}^{t}$$

denotes the predicted value of the classification model for

$${x}_{i}^{t} ,$$

$$h ( {x}_{i}^{t} ; {θ}^{t} )$$

denotes the entropy value of the classification model for

$${x}_{i}^{t} ,$$

φ_{pred} denotes the second preset entropy threshold value,

$${D}_{MD} ( {x}_{i}^{t} , {y}_{i}^{t} , {μ}_{c} , {\sum }_{c} ; {θ}^{t} )$$

denotes the Mahalanobis distance to label c for

$${x}_{i}^{t} ,$$

$$arg {min}_{c ∈ C \neq } {D}_{MD}$$

denotes the minimum Mahalanobis distance, and Δ_{MD} denotes the difference between the minimum Mahalanobis distance and the next minimum Mahalanobis distance.

The adaptation unit 127 may perform the adaptation on the pre-trained classification model based on pieces of data for which the pseudo labels have been generated. The adaptation unit 127 may perform the adaptation based on a cross entropy loss function for minimizing the difference between a class predicted by the classification model and the pseudo label of the corresponding data by inputting, to the classification model, the pieces of data for which the pseudo labels have been generated. Here, pieces of data for which the pseudo labels have not been generated are not used for the adaptation.

In an embodiment, the adaptation unit 127 may perform the adaptation on the classification model using a low-rank adaptation (LoRA) method. In other words, the adaptation unit 127 may perform the adaptation using the LoRA method in order to reduce the number of trainable parameters. Here, the adaptation unit 127 may perform the adaptation using an adaptive loss function L_{adapt} like the following Equation 13.

$${L}_{adapt} ( {x}_{i}^{t} , {\tilde{y}}_{i}^{t} ; {θ}^{t} , \{ A , B \} ) = - {\sum }_{c ∈ C} {\tilde{p}}_{{x}_{i}^{t}} ( c ) ( log {q}_{{x}_{i}^{t}} ( c ; {θ}^{t} ) + log {q}_{{θ}_{L - 1}} ( {x}_{i}^{t} ) ( c ; \{ A , B \} ) ) \qquad ( 13 )$$

Here, A and B are low rank matrices, and respectively expressed as A∈ [symbol] and B∈ [symbol] . In other words, A and B may be two matrices decomposed from an original weight matrix of the classification model and each having a lower rank than the original weight matrix. In the beginning of the adaptation, the matrix B may be set to 0, and the matrix A may be initialized to have Gaussian random values.

Here, a parameter

$${θ}_{L}^{t}$$

for minimizing the difference between a label predicted by the classification model and a pseudo label of the corresponding data may be expressed as a multiplication of the low-dimensional matrices BA. In the beginning, BA is 0 and does not have an influence on the classification model, but matrices B and A are updated during the adaptation phase. Therefore, a phase for applying the low dimensional matrices to the parameter

$${θ}_{L}^{t}$$

of the final hidden layer of the classification model may be expressed as the following Equation 14.

$$\{ A , B \} ← \{ A , B \} - η ∇ {ℒ}_{adapt} ( {x}_{i}^{t} , {\tilde{y}}_{i}^{t} ; {θ}^{t} , \{ A , B \} ) \qquad ( 14 )$$

$${θ}_{L}^{t} ← {θ}_{L}^{t} + BA$$

where η denotes a preset learning rate.

Meanwhile, it is described herein that the final layer among the hidden layers of the classification model is updated by the LoRa method, but the embodiment is not limited thereto. All or some of the hidden layers of the classification model may be updated. The adaptively trained classification model may classify data, which will be input later, into classes.

According to a disclosed embodiment, even in the environment in which the label distribution of data changes, the classification model may be adaptively trained to prevent the degradation in the prediction performance of the classification model and also rapidly respond to data generated in real time.

A module in the specification may mean a functional and structural combination of hardware for performing the technical idea according to the present disclosure and software for driving the hardware. For example, the “module” may mean a logical unit of prescribed codes and hardware resources for executing the prescribed codes, but does not necessarily mean physically connected codes or one kind of hardware.

In FIG. 2, it is described that all the pre-training and adaptation for the classification model are performed in the training device 100, but the embodiment is not limited thereto. As shown in FIG. 6, a first training device 100-1 may include a pre-training module 102 and a second training device 100-2 may include an adaptation module 104. The first training device 100-1 and the second training device 100-2 may be separate devices.

In an embodiment, the first training device 100-1 may be a server computing device for distributing the classification model. The second training device 100-2 may be a computing device (e.g., a mobile phone, a wearable apparatus, a tablet PC, a desk top PC or the like) to which the classification model is distributed.

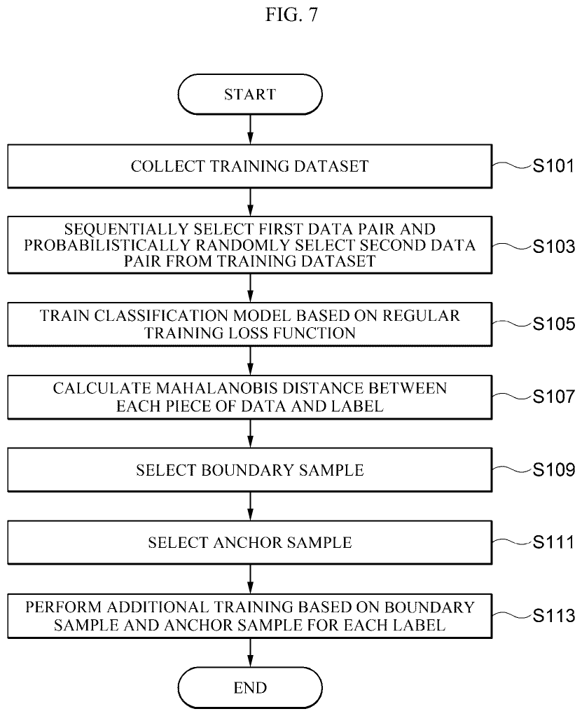

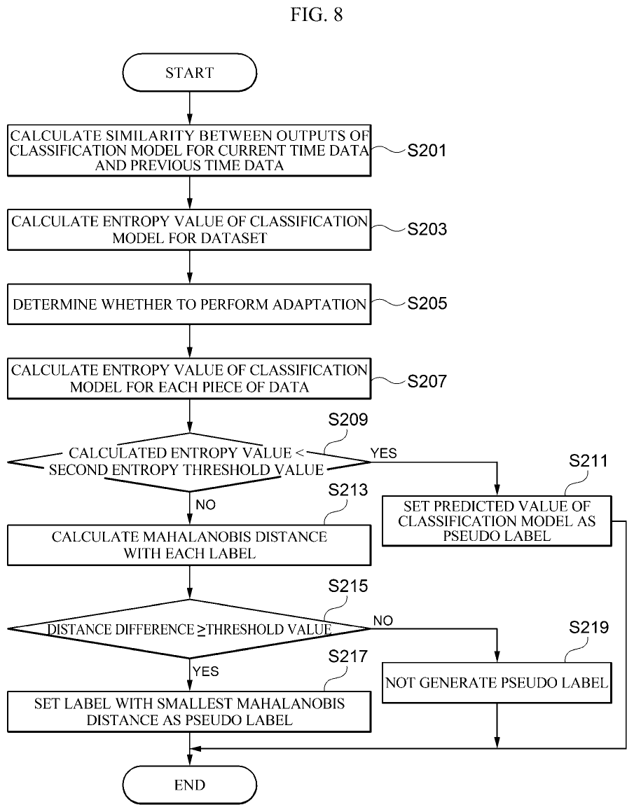

FIG. 7 is a flowchart illustrating a method for training a classification model according to an embodiment of the present disclosure. In the shown flowchart, the method is divided into a plurality of steps, but at least some of the steps may be performed in a reverse order or in combination with other steps, or may be omitted or divided into sub-steps. One or more steps not shown in the drawing may also be additionally performed.

Referring to FIG. 7, in operation S101, the training device 100 may collect the training dataset for training the classification model. The training device 100 may perform matching each piece of training data in the training dataset with a label corresponding to the training data and store the matching result.

In operation S103, the training device 100 may sequentially select the first data pair from the training dataset and stochastically randomly select the second data pair from the training dataset. Here, the data training device 100 may select the second data pair so that the training data corresponding to the minority label in the training dataset is selected at a higher probability than that corresponding to the majority label.

In operation S105, the training device 100 may train the classification model based on the regular training loss function formed by the sum of the first cross entropy loss function and the first contrastive loss function.

In operation S107, the training device 100 may calculate the Mahalanobis distance between each piece of data and the distribution of the labels in the latent representation space. The training device 100 may calculate the average vector and covariance matrix of the pieces of data belonging to each of the labels, and calculate, based on the calculated results, the Mahalanobis distance indicating how far each piece of data is from the label distribution in the latent representation space.

In operation S109, the training device 100 may select, as the boundary sample, a piece of data corresponding to a latent vector with the Mahalanobis distance no smaller than the preset threshold value.

In operation S111, the training device 100 may set, as the anchor sample, the latent vector with the smallest Mahalanobis distance.

In operation S113, the training device 100 may perform additional training using the second contrastive loss function based on the boundary sample and anchor sample for each of the labels. The second contrastive loss function may be a loss function to cause the distance between the anchor sample and the boundary sample to be closer in each of the labels.

FIG. 8 is a flowchart illustrating a method for training the classification model according to another embodiment of the present disclosure. In the shown flowchart, the method is divided into a plurality of steps, but at least some of the steps may be performed in a reverse order or in combination with other steps, or may be omitted or divided into sub-steps. One or more steps not shown in the drawing may also be additionally performed.

Referring to FIG. 8, in operation S201, the training device 100 may calculate the similarity between outputs of the classification model for current time data and previous time data, and, in operation S203, calculate an entropy value of the classification model for the dataset.

In operation S205, based on the similarity between the outputs of the classification model for the current time data and the previous time data and the entropy value of the classification model for the dataset, the training device 100 may determine whether to perform the adaptation.

When the similarity between the outputs of the classification model for the current time data and the previous time data and the entropy value of the classification model for the dataset is smaller than the preset threshold value, and the entropy value of the classification model for the dataset is not smaller than the first preset entropy threshold value, the training device 100 may determine to perform the adaptation.

In operation S207, when it is determined to perform the adaptation, the training device 100 may calculate an entropy value of the classification model for each pieces of data input to the classification model, and, in operation S209, determine whether the calculated entropy value of the classification model is smaller than the second preset entropy threshold value.

As a determined result in operation S209, when the calculated entropy value of the classification model is smaller than the second preset entropy threshold value, the training device 100 in operation S211 may set a predicted value of the classification model as a pseudo label for the corresponding data.

As a determined result in operation S209, when the calculated entropy value of the classification model is not smaller than the second preset entropy threshold value, the training device 100 in operation S213 may calculate the Mahalanobis distance between the latent vector, which is the output of a hidden layer of the classification model for the corresponding data, and the distribution of the labels in the latent representation space.

In operation S215, the training device 100 may determine whether the difference between the minimum Mahalanobis distance and the next minimum Mahalanobis distance is not smaller than a preset threshold value.

As a determined result, when the difference between the minimum Mahalanobis distance and the next minimum Mahalanobis distance is not smaller than the preset threshold value, the training device 100 in operation S217 may select a label with the smallest Mahalanobis distance to set the label as the pseudo label for the corresponding data.

As a determined result, when the difference between the minimum Mahalanobis distance and the next minimum Mahalanobis distance is smaller than the preset threshold value, the training device 100 in operation S219 does not generate the pseudo label for the corresponding data.

In operation S221, the training device 100 may perform the adaptation on the pre-trained classification model based on the pieces of data for which the pseudo labels have been generated.

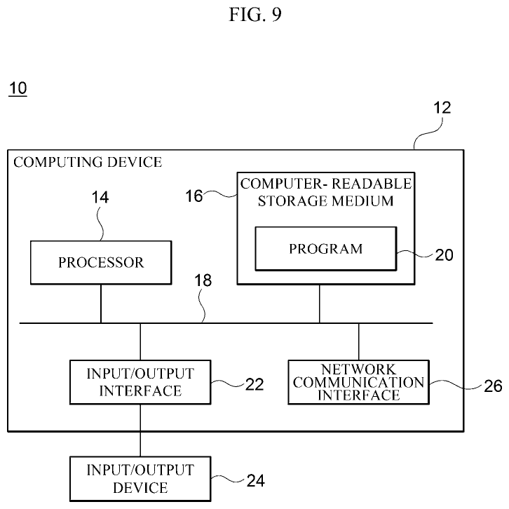

FIG. 9 is a block diagram illustrating a computing environment 10 including a computing device suitable for use in illustrative embodiments. In the shown embodiment, each component may have different functions and capabilities other than those described below, and include additional components other than those described below.

The illustrated computing environment 10 includes a computing device 12. In one embodiment, the computing device 12 may be the training device 100. In addition, the computing device 12 may be the first training device 100-1. In addition, the computing device 12 may be the second training device 100-2.

The computing device 12 includes at least one processor 14, a computer-readable storage medium 16, and a communication bus 18. The processor 14 may cause the computing device 12 to operate according to the aforementioned illustrative embodiments. For example, the processor 14 may execute one or more programs stored in the computer-readable storage medium 16. The one or more programs may include one or more computer-executable instructions, and when executed by the processor 14, the computer-executable instructions may cause the computing device 12 to perform operations according to the illustrative embodiments.

The computer-readable storage medium 16 is configured to store the computer-executable instructions or program codes, program data and/or other suitable types of information. The programs 20 stored in the computer-readable storage medium 16 include a set of instructions executable by the processor 14. In one embodiment, the computer-readable storage medium 16 includes a memory (a volatile memory such as a random access memory, a nonvolatile memory, or a suitable combination thereof), one or more magnetic disk storage devices, optical disk storage devices, flash memory devices, or any other types of storage media that are accessible by the computing device 12 and capable of storing desired information, or a suitable combination thereof.

The communication bus 18 interconnects various other components of the computing device 12 including the processor 14 and the computer-readable storage medium 16.

The computing device 12 may also include one or more input/output interfaces 22 for one or more input/output devices 24 and one or more network communication interfaces 26. The input/output interfaces 22 and the network communication interfaces 26 are connected to the communication bus 18. The input/output device 24 may be connected to other components of the computing device 12 through the input/output interfaces 22. The illustrative input/output device 24 may include a pointing device (a mouse or a track pad. or the like), a keyboard, a touch input device (a touch pad, a touch screen, or the like), an input device such as a voice or sound input device, various types of sensor devices, and/or an imaging device, and/or an output device such as a display device, a printer, a speaker, and/or a network card. The illustrative input/output device 24 which is one component constituting the computing device 12 may be included inside the computing device 12, and may be connected to the computing device 12 as a separate device from the computing device 12.

According to the disclosed embodiments, the classification performance of the classification model may be improved even for data at the boundary of a label as the label imbalance in the training dataset is addressed in the pre-training phase.

In addition, by performing the adaptation on the classification model even in an environment in which the label distribution of data changes, the classification model is adaptively trained to prevent the degradation in the prediction performance of the classification model and also rapidly respond to data generated in real time.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for training a classification model performed by a computing device comprising one or more processors and a memory for storing one or more programs executed by the one or more processors, the method comprising:
sequentially selecting a first data pair from a training dataset and stochastically selecting a second data pair from the training dataset; and
inputting the first and second data pairs to a classification model to train the classification model,
wherein each of the first and second data pairs comprises data and a label corresponding to the data.

2. The method of claim 1, wherein, in the selecting of the second data pair, data corresponding to a minority label is allowed to be selected at a higher probability than data corresponding to a majority label in the training dataset.

3. The method of claim 2, wherein, in the training of the classification model, the classification model is trained by a first cross entropy loss function and a first contrastive loss function,
the first cross entropy loss function comprises:
a (1-1)-th cross entropy loss function for minimizing a difference between a class predicted by the classification model for first data between the first data pair and a label of the first data between the first data pair; and
a (1-2)-th cross-entropy loss function for minimizing a difference between a class predicted by the classification model for second data between the second data pair and a label of the second data between the second data pair, and
the first contrast loss function is a loss function for causing same labels to be closer and different labels to be further apart in latent vectors output from one or more hidden layers of the classification model.

4. The method of claim 1, further comprising selecting, as a boundary sample, a piece of data that is a latent vector output from the hidden layer of the classification model and positioned at a boundary of the label.

5. The method of claim 4, wherein the selecting as the boundary sample comprises:
calculating a Mahalanobis distance between a distribution of the labels and the latent vector output from the hidden layer of the classification model; and
selecting, as the boundary sample of the corresponding label, the latent vector with the Mahalanobis distance no smaller than a preset threshold value.

6. The method of claim 5, further comprising:
setting an anchor sample for each of the labels based on the Mahalanobis distance; and
performing additional training on the classification model based on the boundary sample and the anchor sample for each of the labels.

7. The method of claim 6, wherein, in the setting of the anchor sample, a latent vector with a minimum Mahalanobis distance is set as the anchor sample for each of the labels.

8. The method of claim 6, wherein the performing of the additional training comprises performing the additional training using a second contrastive loss function that causes a distance between the anchor sample and the boundary sample in each of labels to be closer.

9. The method of claim 1, further comprising determining whether to perform adaptation on the trained classification model based on data collected in real time.

10. The method of claim 9, wherein the determining of whether to perform the adaptation comprises:
calculating a similarity between an output of the classification model for current time data and an output of the classification model for previous time data; and
determining not to perform the adaptation when the calculated similarity is not smaller than a preset similarity threshold value.

11. The method of claim 9, wherein the determining of whether to perform the adaptation comprises:
calculating an entropy value of the classification model for a dataset collected in real time; and
determining not to perform the adaptation when the calculated entropy value of the classification model is smaller than a first preset entropy threshold value.

12. The method of claim 9, further comprising:
generating a pseudo label for each piece of data input to the classification model when the adaptation is determined to be performed; and
performing the adaptation on the trained classification model based on pieces of data for which the pseudo label have been generated.

13. The method of claim 12, wherein the generating of the pseudo label comprises:
calculating an entropy value of the classification model for each piece of data input to the classification model; and
setting a predicted value of the classification model as a pseudo label for the corresponding data when the calculated entropy value of the classification model is smaller than a second preset entropy threshold value.

14. The method of claim 13, wherein, in the generating of the pseudo label, a pseudo label is generated based on a latent vector that is an output from the hidden layer of the classification model for the corresponding data when the calculated entropy value of the classification model is not smaller than the second preset entropy threshold value.

15. The method of claim 14, wherein the generating of the pseudo label comprises:
calculating Mahalanobis distances between a distribution of the labels and the latent vector for the corresponding data; and
generating the pseudo label for the corresponding data based on the calculated Mahalanobis distances.

16. The method of claim 15, wherein the generating of the pseudo label comprises:
calculating a difference between a minimum Mahalanobis distance and a next minimum Mahalanobis distance; and
setting a label with a smallest Mahalanobis distance as the pseudo label for the corresponding data when the calculated difference is not smaller than a preset threshold value.

17. The method of claim 16, wherein, in the generating of the pseudo label, the pseudo label is not generated for the corresponding data when the calculated difference is smaller than the preset threshold value.

18. A computing device comprising:
one or more processors;
a memory; and
one or more programs stored in the memory and executed by the one or more processors, the one or more programs comprising:
an instruction for sequentially selecting a first data pair from a training dataset and stochastically selecting a second data pair from the training dataset, and
an instruction for inputting the first and second data pairs to a classification model to train the classification model,
wherein each of the first and second data pairs comprises data and a label corresponding to the data.

19. A computer program stored in a non-transitory computer readable storage medium, the computer program comprising one or more instructions,
wherein, when executed by a computing device comprising one or more processors, the instructions cause the computing device to perform:
sequentially selecting a first data pair from a training dataset and stochastically selecting a second data pair from the training dataset; and
inputting the first and second data pairs to a classification model to train the classification model,
wherein each of the first and second data pairs comprises data and a label corresponding to the data.
